(19) United States
(12) Patent Application Publication
(10) Pub. No.: US 2013/0318625 A1
(43) Pub. Date: Nov. 28, 2013

(54) METHOD FOR PROTECTING DATA STORED IN DEVICE AND DEVICE THEREOF

(71) Applicant: Ke Fan, Beijing (CN)

(72) Inventor: Ke Fan, Beijing (CN)

(21) Appl. No.: 13/885,954

(22) PCT Filed: Nov. 11, 2011
(86) PCT No.: PCT/CN2011/082325

§ 371 Date: Aug. 2, 2013

(30) Foreign Application Priority Data
Nov. 17, 2010 (CN) 201010547532.9

(51) Int. Cl. G06F 21/62

(52) U.S. Cl. CPC G06F 21/62
USPC 726/27

(57) ABSTRACT

The present invention provides a method for protecting data stored in a device, comprising: automatically acquiring, by the device, fingerprint information of a current user of a device; judging whether the acquired fingerprint information of the current user of the device is the same as registered user's fingerprint information preset in the device; and if the judgment result is the same, calling private data stored in the device, and otherwise calling non-private data stored in the device. The present invention further provides a corresponding device. Through the present invention, it is able to protect the private data of the user in a more hidden manner and to improve the security of the private data.

The present application claims the priority of the Chinese patent application No. 201010547532.9, filed on Nov. 17, 2010 and entitled “Method for protecting data stored in device and device thereof”, which is incorporated herein by reference in its entirety.

### TECHNICAL FIELD

The present invention relates to the field of data security, in particular to a method for protecting data stored in a device and the device thereof.

### BACKGROUND

Currently, biometric identification technologies, such as a fingerprint identification technology, have been widely used to protect private data stored in a terminal such as a mobile phone and a Personal Digital Assistant (PDA). A user enters his fingerprint information into the terminal such as a mobile phone and a PDA, and registers in the terminal as a registered user so as to set an access privilege on some programs or data. These programs or data with the access privilege are private data, and the programs or data without the access privilege are non-private data. For example, the access privilege may be set on address book, short messages, communication records, schedule, e-mail, figures, videos, audios, file manager and browsing history, so that a non-registered user cannot access to the data with the access privilege.

The inventor finds that, in the prior art, when the user has set the private data and wants to access to the data, he is prompted to enter in the fingerprint information. As a result, the non-registered user using the device will be aware of the fact that the fingerprint identification technology is used, i.e., there probably exist the private data of the registered user in the device. Hence, the method for protecting the private data in the terminal such as a mobile phone and a PDA by using the fingerprint identification technology in the prior art is not hidden enough, and it may easily reveal the fact that the private data is stored in the device, thereby reduce the security and reliability of the private data to be protected.

### SUMMARY

The present invention provides a method for protecting data, so as to improve the security and reliability of private data to be protected when the private data is protected in a terminal using a fingerprint identification technology.

The method for protecting data comprises:

automatically acquiring, by a device, fingerprint information of a current user of a device;

judging whether the acquired fingerprint information of the current user of the device is the same as registered user's fingerprint information preset in the device; and

if the judgment result is the same, calling private data stored in the device, and otherwise calling non-private data stored in the device.

The present invention further provides a device, comprising:

a fingerprint reading module, configured to automatically acquire fingerprint information of a current user of the device;

an identifying module, configured to match the acquired fingerprint information of the current user of the device with registered user's fingerprint information preset in the device; and

a data calling module, configured to call private data stored in the device if the identification result of the identifying module is the same, and otherwise call non-private data stored in the device.

According to the method for protecting data stored in a device and the device thereof, when the current user accesses to applications preset in the device, the device will automatically acquire the fingerprint information of the current user of the device, and match the acquired fingerprint information with the registered user's fingerprint information stored therein. If the acquired fingerprint information is the same as the registered user's fingerprint information, the device will call the private data, and if not, call the non-private data. During the above procedure, the device does not prompt the current user who accesses to the preset applications to input the fingerprint information, so the current user will not realize that his fingerprint information has been acquired, and can still use the selected applications normally. All the actions, including acquiring the fingerprint information of the current user of the device, matching it with the registered user's fingerprint information and calling the corresponding data in accordance with the matching result, are done by the device without the current user's awareness, and the functions of the triggered applications will not be affected, so the user will not realize that the device has been provided with a fingerprint identification function to protect the private data. As a result, it is able to protect the private data to be protected by the registered user in a more hidden manner, and to improve the security and reliability of the private data.

### BRIEF DESCRIPTION OF THE DRAWINGS

FIG. 1 is a schematic view showing a device 100 according to one embodiment of the present invention;

FIG. 2 is a schematic view showing a device 200 according to another embodiment of the present invention;

FIG. 3 is a schematic view showing a method 3000 for protecting data stored in a device according to one embodiment of the present invention; and

FIG. 4 is a schematic view showing a method 4000 for protecting data stored in a device according to another embodiment of the present invention.

### DETAILED DESCRIPTION

The technical solutions of the present invention will be described hereinafter in conjunction with the drawings.

The device mentioned in the present invention may use the method of entering registered user's fingerprint information in the prior art for user registration. For example, the user at first enters one or more fingerprints, enters a fingerprint again and matches it with the previous one or more of fingerprints. If they are the same, the entered one or more fingerprints are recorded, the registration is completed successfully. Otherwise, the user shall re-enter the fingerprints. The method of registering the fingerprint information with the device is known in the prior art, and will not be repeated herein.

The user registration has been completed in the device mentioned hereinafter. That is, registered user's fingerprint information has been stored in the device, and the private data to be protected and the corresponding applications have been set.

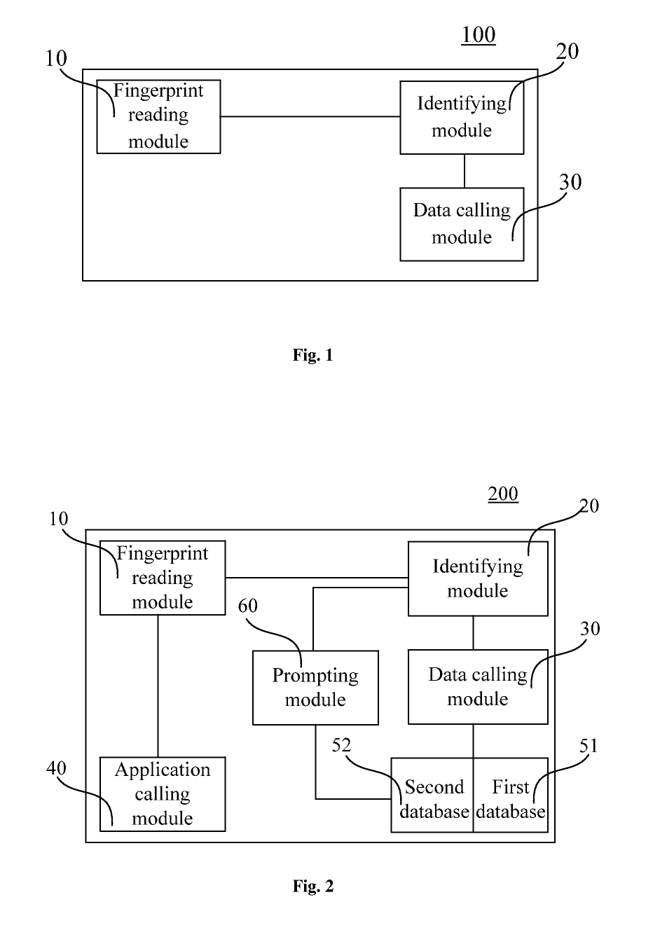

FIG. 1 is a schematic view showing a device 100 according to one embodiment of the present invention. As shown in FIG. 1, the device 100 comprises a fingerprint reading module 10, an identifying module 20 and a data calling module 30.

In this embodiment, the fingerprint reading module 10 may automatically acquire fingerprint information of a current user of a device. The identifying module 20 may match the acquired fingerprint information of the current user of the device with registered user's fingerprint information stored in the device 100. If these two kinds of fingerprints are the same, the current user is determined as a registered user, and if not, the current user is determined as a non-registered user. When the current user is determined as the registered user, the data calling module 30 calls private data stored in the device, and when the current user is determined as the non-registered user, the data calling module 30 may also call non-private data stored in the device.

Mobile phone is taken as an example hereinafter, where the registered user sets contact information of a contact X as the private data, and sets an application “address book” as a preset application to be protected.

In one embodiment of the present invention, the fingerprint reading module 10 may automatically acquire the fingerprint information of the current user of the device in real time. For example, when a first user touches a touch screen of the mobile phone, the fingerprint reading module 10 automatically acquires the first user's fingerprint information. The identifying module 20 matches the acquired first user's fingerprint information with the registered user's fingerprint information stored in the device 100. If the matching result is the same, the first user is determined as the registered user. Then, the data calling module 30 calls the private data stored in the mobile phone, i.e., the contact information of the contact X, or calls the non-private data stored in the mobile phone. At this time, if a second user uses the mobile phone, the fingerprint reading module 10 will automatically acquire the second user's fingerprint information. The identifying module 20 matches the acquired second user's fingerprint information with the registered user's fingerprint information stored in the device 100. If the matching result is not the same, the second user is determined as the non-registered user. The data calling module 30 then calls the non-private data stored in the mobile phone, i.e., the non-registered user cannot see the private data set by the registered user.

FIG. 2 is a schematic view showing a device 200 according to another embodiment of the present invention. As shown in FIG. 2, in another embodiment, the device 200 may further comprise an application calling module 40 configured to receive input from the current user so as to trigger a application preset in the device 200. The fingerprint reading module 10 may automatically acquire the fingerprint information of the current user of the device when the preset application is triggered by the current user. When the current user is determined by the identifying module 20 as the registered user, the data calling module 30 calls via the application the private data corresponding to the application and stored in the device. When the current user is determined by the identifying module 20 as the non-registered user, the data calling module 30 calls via the application the non-private data and corresponding to the application stored in the device.

The device 200 may be any device where the private data needs to be protected and a fingerprint identifying means is provided, e.g., a mobile phone or a PDA. The application calling module 40 may comprise a touch screen Liquid Crystal Display (LCD) which covers a body of the device 200. The fingerprint reading module 10 may be a transparent Thin Film Transistor (TFT) (including a sensor TFT and a switching TFT) and may be arranged onto the touch screen LCD. In one embodiment, the user can see the information displayed on the touch screen LCD via the fingerprint reading module 10. The technologies of combining the fingerprint reading module 10 with LCD in the prior art may be directly applied to the present invention, and they will not be repeated herein.

Alternatively, when the contact information of the contact X is set as the private data, the relevant information of the contact X will be automatically set as the private data, and the applications corresponding to the relevant information will also be automatically set as the preset applications to be protected. For example, the device will automatically set the relevant information of the contact X in a short message as the private data, and automatically set an application “short message” as the preset application to be protected. The application calling module 40 automatically receives the input from the current user who is pressing the touch screen by fingers, thereby triggers the application “address book”. The fingerprint reading module 10 automatically acquires the fingerprint information of the current user of the device, and the identifying module 20 matches the acquired fingerprint information with the registered user's fingerprint information stored in the device 100. If the matching result is the same, the current user is determined as the registered user, and the data calling module 30 calls the contact information of the contact X or the non-private data stored in the mobile phone via the application “address book”. If matching result is not the same, the current user is determined as the non-registered user, and the data calling module 30 calls the non-private data stored in the mobile phone via the application “address book”, i.e., the non-registered user cannot see the contact information of the contact X.

In the embodiment, the device will not send any prompt to the non-registered user to input his fingerprint information, even when the current user has triggered the preset application. The fingerprint reading module 10 will automatically acquire the fingerprint information of the current user of the device, i.e., the current user will not realize that his fingerprint information has been acquired and can still use the selected application normally. All the actions, including acquiring the fingerprint information of the current user of the device, matching the fingerprint information with the registered user's fingerprint information and calling corresponding data in accordance with the matching result, are “silently” done by the device without the current user's awareness, and the function of the triggered application will not be affected, so the non-registered user will not realize that the device has been provided with a fingerprint identification function to protect the private data. As a result, it is able to protect the private data to be protected by the registered user in a more hidden manner, and to improve the security and reliability of the private data without decreasing the non-registered user experience.

In another embodiment, the private data and the non-private data may optionally be stored in different databases. As shown in FIG. 2, the device 200 further comprises a first database 51 and a second database 52 for storing the private data and the non-private data respectively. For example, when the current user who calls the preset application is determined as the registered user, the data calling module 30 calls the private data stored in the first database 51 via the application, and when the current user is determined as the non-registered user, the data calling module 30 calls the non-private data stored in the second database 52 via the application. In the above-mentioned example, the contact information of the contact X may be stored in the first database 51. When the identifying module 20 determines the current user as the registered user, the data calling module 30 calls the contact information of the contact X stored in the first database 51 or the non-private data stored in the second database 52 via the application “address book”.

In this embodiment, the data of the registered user and the data of the non-registered data are stored in the first database 51 and the second database 52 respectively. In other words, the device 200 may provide different data for different users, rather than hiding or shielding the private data in one database. Hence, as compared with the device in the prior art, the device in this embodiment is intelligent and can improve the security of the private data.

Alternatively, in the device 200, when the current user triggers the preset application but the fingerprint reading module 10 cannot acquire the fingerprint information of the current user of the device, the identifying module 20 will determine the current user as the non-registered user. When the current user uses an object other than his finger, e.g., clicking on the touch screen of the mobile terminal by a handwriting pen, to trigger the preset application such as the application “address book”, the fingerprint reading module 10 cannot acquire the fingerprint information of the current user of the device. At this time, the identifying module 20 determines the user as the non-registered user, and the data calling module 30 will call the non-private data via the application “address book”. For example, the data calling module 30 in the device 200 calls the non-private data from the second database 52 via the application “address book”.

In one embodiment, the registered user may include a primary registered user and a secondary registered user. For example, in the device 200, the private data of the primary registered user and the private data of the secondary registered user are stored in the first database 51. When the identifying module 20 determines that the current user is the primary registered user, the data calling module 30 calls the private data of the primary registered user from the first database 51 via the triggered application. When the identifying module 20 determines that the current user is the secondary registered user, the data calling module 30 calls the private data of the secondary registered user from the first database 51 via the triggered application. The privilege level of the primary registered user may be equal to, or higher than, that of the secondary registered user. If the privilege level of the primary registered user is equal to that of the secondary registered user, the users can see each other's private data or the users cannot see each other's private data. If the privilege level of the primary registered user is higher than that of the secondary registered user, the primary registered user can see the private data of the secondary registered user while the secondary registered user cannot see the private data of the primary registered user. Of course, the private data of the secondary registered user may also be stored in a database different from the database in which the private data of the primary registered user is stored. For example, a third database may be provided to store therein the private data of the secondary registered user. Correspondingly, when the identifying module 20 determines that the current user is the secondary registered user, the data calling module 30 calls the private data of the secondary registered user from the third database via the triggered application.

Alternatively, when the non-registered user uses the preset application, operation information about the application may also be stored in the device 100 and/or the device 200. For example, in the device 200, the operation information indicating that the non-registered user has ever used the application may be stored in the second database 52. In the above-mentioned example, the operation information indicating that the non-registered user has ever used the application “address book” may be recorded in the second database 52.

In addition, in another embodiment, the device 200 may further comprise a prompting module 60. As shown in FIG. 2, when the operation information indicating that the non-registered user has ever used the preset application is stored in the device 200 and the registered user triggers the same application again, the prompting module 60 will send a prompt message to prompt the registered user whether or not to call and/or delete the operation information. In the above-mentioned example, the operation information indicating that the non-registered user has ever used the application “address book” is stored in the second database 52, and when the registered user triggers the application “address book” again, the prompting module 60 will send a prompt message to prompt the registered user whether or not to call and/or delete the operation information. Alternatively, in one embodiment, a threshold may be set so that the operation information can be stored in the second database 52 in accordance with a preset time and/or space. For example, the time threshold may be set as 24 hours for storing the operation information in the second database 52, and the stored operation information will be automatically deleted when this period ends, or the space for storing the operation information may be set as 64M at most.

Alternatively, the application set by the registered user and required to be protected may be a sub-application (which can also be understood as a specific operation of an application). For example, the registered user may set the sub-application “outbox” of the application “short message” as the application to be protected, and the non-registered user can normally use the other sub-applications of the application “short message”, e.g., “inbox”, “draft box” and “unread messages”. The non-registered user can still normally use the sub-application “outbox”, but the data calling module 30 can merely call the non-private data.

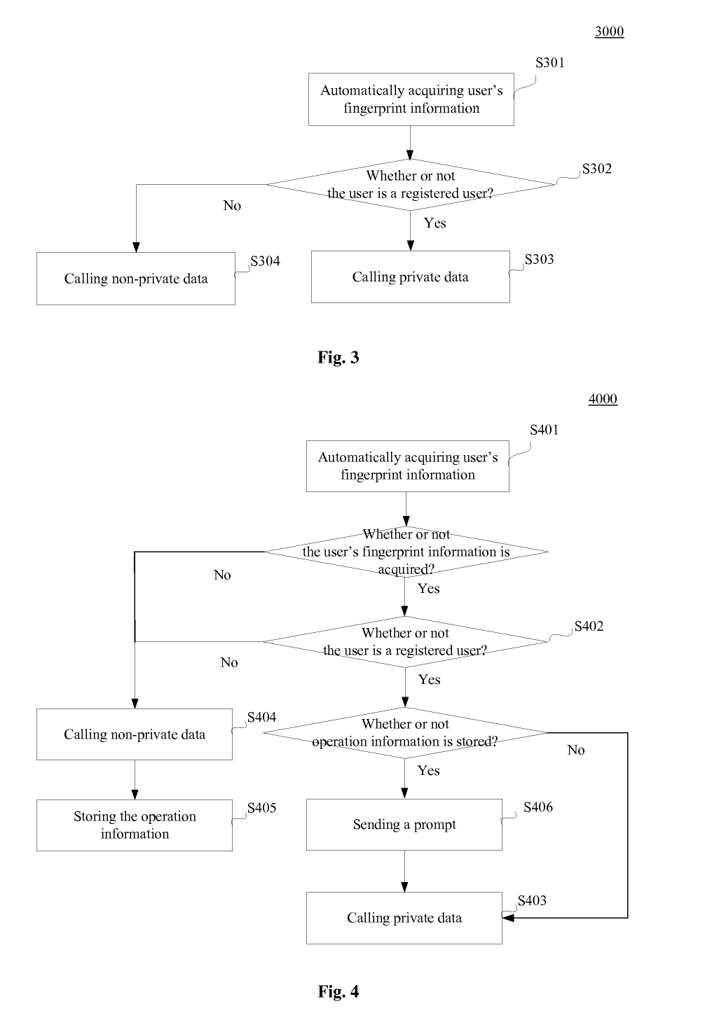

FIG. 3 is a schematic view showing a method 3000 for protecting data stored in a device according to one embodiment of the present invention.

As shown in FIG. 3, in step S301, the device automatically acquires fingerprint information of the current user of the device. In step S302, the device matches the acquired fingerprint information of the current user of the device with the registered user's fingerprint information stored in the device. If the matching result is the same, the current user is determined as the registered user, and the device calls private data in step S303. If the matching result is not the same, the current user is determined as the non-registered user, and the device calls non-private data in step S304. In this embodiment, the non-registered user can still use the function of an application normally, but cannot see the private data of the registered user.

In one embodiment, the device may automatically acquire the current user fingerprint information in real time in step S301. For example, if the registered user sets contact information of a contact X in a mobile phone as the private data and sets an application “address book” as a preset application to be protected, when a first user touches a touch screen of the mobile phone by his finger in step S301, the device will automatically acquire the first user's fingerprint information. The device can acquire the fingerprint information of the current user of the device in real time, so it can acquire the fingerprint information as long as the current user touches the touch screen by his finger. Then, the device matches the acquired first user fingerprint information with the registered user fingerprint information stored in the device in step S302. The matching result is the same, so the first user is determined as the registered user, and the device calls the contact information of the contact X in step S303. At this time, if a second user uses the mobile phone, the device will automatically acquire the second user's fingerprint information in step S301, and matches the acquired second user's fingerprint information with the registered user's fingerprint information stored in the device 100 in step S302. The matching result is not the same, so the second user is determined as the non-registered user, and the device calls the non-private data in step S304, i.e., the non-registered user cannot see the private data of the registered user.

In another embodiment, when the current user triggers the preset application, the device will automatically acquire the fingerprint information of the current user of the device in step S301, and match the acquired fingerprint information with the registered user's fingerprint information stored in the device in step S302. If the matching result is the same, the current user is determined as the registered user, and the device calls the private data corresponding to the application in step S303. If the matching result is not the same, the current user is determined as the non-registered user, and the device calls the non-private data corresponding to the application in step S304.

Mobile phone having a touch screen is taken as an example, where the contact information of the contact X is set by the registered user as the private data and the application “address book” is set as the preset application to be protected. When the current user clicks on the touch screen by his finger to trigger the application “address book”, the device will automatically acquire the fingerprint information of the current user of the device in step S301, and match the acquired fingerprint information with the registered user's fingerprint information stored in the device in step S302. If the matching result is the same, the current user is determined as the registered user, and then the contact information of the contact X or the non-private data is called via the application “address book” in step S303. If the matching result is not the same, the current user is determined as the non-registered user, and the non-private data is called via the application “address book” in step S304, i.e., the non-registered user cannot see the contact information of the contact X.

FIG. 4 is a schematic view showing a method 4000 for protecting data stored in a device according to another embodiment of the present invention. The same steps as those in method 3000 will not be repeated herein.

In another embodiment, the private data and the non-private data may be stored in different databases. For example, the device may comprise a first database for storing the private data of the registered user and a second database for storing the non-private data. If the current user is determined as the registered user in step S402, the device will call the private data stored in the first database via the application in step S403. If the current device is determined as the non-registered user in step S402, the device will call the non-private data stored in the second database via the application in step S404. For yet another example, if the current user is determined by the mobile phone as the registered user, the mobile phone will call the contact information of the contact X stored in the first database or the non-private data stored in the second database via the application “address book in step S403. If the current user is determined as the non-registered user in step 402, the mobile terminal will call the non-private data stored in the second database via the application “address book” in step S404.

In addition, if the current user triggers the preset application but the device cannot acquire the current user fingerprint information in step S401, the current user is determined as the non-registered user. For example, when the current user clicks on the touch screen by a handwriting pen to trigger the application “address book”, the mobile phone cannot acquire the fingerprint information of the current user of the device and the current user is determined as the non-registered user. Then, the mobile phone calls the non-private data via the application “address book” in step S404. For example, the mobile phone will call the non-private data from the second database via the application “address book”.

Alternatively, the registered user may include a primary registered user and a secondary registered user. For example, the private data of the primary registered user and the private data of the secondary registered user are stored in the first database. When the current user is determined as the primary registered user in step S402, the device calls the private data of the primary registered user from the first database via the triggered application in step S403. When the current user is determined as the secondary registered user in step S402, the device calls the private data of the secondary registered user from the first database via the triggered application in step S403. Of course, the private data of the secondary registered user may also be stored in a database different from the database in which the private data of the primary registered user is stored. For example, a third database may be provided to store therein the private data of the secondary registered user.

In another embodiment, when the non-registered user uses the preset application, operation information about the application may also be stored in the device in step S405. For example, in step S405, the operation information indicating that the non-registered user has ever used the application may be stored in the second database. For yet another example, in step S405, the operation information indicating that the non-registered user has ever used the application “address book” may be recorded in the second database of the mobile phone.

Alternatively, when the operation information indicating that the non-registered user has ever used the preset application is stored in the device and the registered user triggers the same application again, the device will send a prompt message to prompt the registered user whether or not to call and/or delete the operation information in step S406. For example, the operation information indicating that the non-registered user has ever used the application “address book” is stored in the mobile phone, and when the registered user triggers the application “address book” again, the mobile phone will send a prompt message to prompt the registered user whether or not to call and/or delete the operation information. Alternatively, a threshold may be set so that the operation information can be stored in the device in accordance with a preset time and/or space. For example, the time threshold may be set as 24 hours for storing the operation information in the second database, and the stored operation information will be automatically deleted when this period ends, or the space for storing the operation information may be set as 64M at most.

The above-mentioned embodiments are merely for the illustrative purpose, and a person skilled in the art can make modifications to the embodiments within the scope defined by the claims of the present invention.

According to the method and device for protecting data stored in the device, when the current user accesses to the applications preset in the device, the device will automatically acquire the fingerprint information of the current user of the device, and match the acquired fingerprint information with the registered user's fingerprint information stored therein. If the acquired fingerprint information is the same as the registered user's fingerprint information, the device will call the private data, and if not, call the non-private data. During the above procedure, the device does not prompt the current user who accesses to the preset applications to input the fingerprint information, so the current user will not realize that his fingerprint information has been acquired, and can still use the selected applications normally. All the actions, including acquiring the fingerprint information of the current user of the device, matching it with the registered user's fingerprint information and calling the corresponding data in accordance with the matching result, are done by the device without the current user's awareness, and the functions of the triggered applications will not be affected, so the user will not realize that the device has been provided with a fingerprint identification function to protect the private data. As a result, it is able to protect the private data to be protected by the registered user in a more hidden manner, and to improve the security and reliability of the private data.

It should be appreciated that, the present invention may be provided as a method, a system or a computer program product, so the present invention may be in the form of full hardware embodiments, full software embodiments, or combinations thereof. In addition, the present invention may be in the form of a computer program product implemented on one or more computer-readable storage mediums (including but not limited to disk memory, CD-ROM and optical memory) including computer-readable program codes.

The present invention is described with reference to the flow charts and/or block diagrams showing the method, device (system) and computer program product according to the embodiments of the present invention. It should be appreciated that each process and/or block, or combinations thereof, in the flow charts and/or block diagrams may be implemented via computer program commands. These computer program commands may be applied to a general-purpose computer, a special-purpose computer, an embedded processor or any other processor of programmable data processing equipment, so as to form a machine, thereby to obtain the means capable of effecting the functions specified in one or more processes in the flow charts and/or one or more blocks in the block diagrams in accordance with the commands executed by the computer or the processor of the other programmable data processing equipment.

These computer program commands may also be stored in a computer-readable memory capable of guiding the computer or the other programmable data processing equipment to work in a special manner, so as to form a product including a command device capable of effecting the functions specified in one or more processes in the flow charts and/or one or more blocks in the block diagrams.

These computer program commands may also be loaded onto a computer or the other programmable data processing equipment, so as to perform a series of operations thereon and generate the processings implemented by the computer, thereby to provide the steps capable of effecting the functions specified one or more processes in the flow charts and/or one or more blocks in the block diagrams in accordance with the instructions.

Although the preferred embodiments are described above, a person skilled in the art may make modifications and alterations to these embodiments in accordance with the basic concept of the present invention. So, the attached claims are intended to include the preferred embodiments and all of the modifications and alterations that fall within the scope of the present invention.

What is claimed is:

1. A method for protecting data, comprising:
automatically acquiring fingerprint information of a current user of a device;
judging whether the acquired fingerprint information of the current user of the device is the same as registered user's fingerprint information preset in the device; and
if the judgment result is the same, calling private data stored in the device, and otherwise calling non-private data stored in the device.

2. The method according to claim 1, wherein the step of automatically acquiring fingerprint information of the current user of the device comprises:
automatically acquiring user's fingerprint information when a current user triggers an application preset in the device.

3. The method according to claim 2, wherein the step of if the judgment result is the same, calling private data stored in the device, and otherwise calling non-private data stored in the device comprises:
if the judgment result is the same, the application calls the private data corresponding to the application, and otherwise, the application calls the non-private data corresponding to the application.

4. The method according to claim 1, wherein the step of automatically acquiring fingerprint information of the current user of the device comprises:
automatically acquiring fingerprint information of the current user of the device in real time.

5. The method according to claim 1, wherein the step of automatically acquiring fingerprint information of the current user of the device comprises:
a fingerprint reading unit of the device automatically acquires fingerprint information of the current user of the device when the current user presses a touch screen of the device.

6. The method according to claim 3, wherein if the judgment result is not the same, the method further comprises:
recording operation information of the application so that a registered user can know the operation made by a non-registered user via the application according to the recorded operation information.

7. The method according to claim 1, wherein if the judgment result is the same, the method further comprises:
calling the non-private data stored in the device.

8. The method according to claim 1, wherein when the fingerprint information of the current user of the device cannot be acquired, the method further comprises:
calling the non-private data stored in the device.

9. A device, comprising:
a fingerprint reading module, configured to automatically acquire fingerprint information of a current user of the device;
an identifying module, configured to match the acquired fingerprint information of the current user of the device with registered user's fingerprint information preset in the device; and
a data calling module, configured to call private data stored in the device if the identification result of the identifying module is the same, and otherwise call non-private data stored in the device.

10. The device according to claim 9, further comprising:
an application calling module, configured to receive input from the current user of the device so as to trigger an application preset in the device.

11. The device according to claim 10, wherein
the fingerprint reading module is specifically configured to automatically acquire the fingerprint information of the current user of the device when the application is triggered.

12. The device according to claim 9, wherein
the fingerprint reading module is specifically configured to automatically the fingerprint information of the current user of the device in real time.

13. The device according to claim 10, wherein
the application calling module comprises a touch screen for receiving a command to trigger the application.

14. The device according to claim 9, further comprising:
a first database, configured to store the private data; and
a second database, configured to store the non-private data.

15. The device according to claim 14, wherein
the second database is further configured to record operation information of the application if the identification result of the identifying module is not the same.

16. The device according to claim 9, wherein
the data calling module is further configured to call the non-private data stored in the device if the identification result of the identifying unit is the same.

17. The device according to claim 11, wherein
the data calling module is further configured to call the non-private data stored in the device when the fingerprint reading module cannot acquire the fingerprint information of the current user of the device.
